(19) United States
(12) Patent Application Publication
(10) Pub. No.: US 2010/0131563 A1
(43) Pub. Date: May 27, 2010

(54) System and methods for automatic clustering of ranked and categorized search objects

(76) Inventor: Hongfeng Yin, Cupertino, CA (US)

Correspondence Address: GERALD B ROSENBERG;NEW TECH LAW, 260 SHERIDAN AVENUE, SUITE 208, PALO ALTO, CA, 94306-2009, US

(21) Appl. No.: 12/313,860

(22) Filed: Nov. 25, 2008

(51) Int. Cl. G06F 7/06; G06F 17/30; G06F 7/00

(52) U.S. Cl. 707/794; 707/E17.014

(57) ABSTRACT

A search results page includes multiple search lists generated by multiple clustering operations applied to an initial match set of documents selected based on a user query. A first result list is constructed by clustering a top-n set of documents by primary domain address and sorting based on extrinsic ranking factors such that the first list includes a ranked and ordered list of primary domain linked anchor text. A second result list is constructed by clustering the top-n set of documents based on a unified ranked occurrence of keywords within the top-n set of documents. The generated second list contains a plurality of cluster class references with each of the cluster class reference including a ranked ordered sub-list of the keywords occurring within the top-n set of documents and respectively associated with the cluster class reference, each of the keywords of the ranked ordered sub-lists including linking references to a corresponding one of the top-n set of documents. A third result list is constructed by clustering the top-n set of documents based on a ranked frequency of occurrence of internally linked anchor texts. The generated third result list includes the top-n set of the internally linked anchor texts and respective ranked and ordered sub-lists of linking references to primary domain Web-pages containing the corresponding one of the internally linked anchor texts.

### BACKGROUND OF THE INVENTION

1. Field of the Invention

The present invention is generally related to the organized retrieval of information from large scale data collections and, in particular, to a system and methods of developing and presenting an efficiently structured representation of accessible content through automated clustering of ranked and categorized search objects.

2. Description of the Related Art

The World Wide Web (Web) represents perhaps the largest, most diverse and rapidly growing publically accessible data collection. Because of the size of the collection, as well as the fundamentally open nature of the collection to independent content additions, this Web-based content is considered essentially unstructured. Various types of Information Retrieval (IR) systems have been developed in an ongoing effort to enable users to locate desired information within the data collection. These IR systems are generally implemented as search engines accessible through a Web-based user interface enabling query submission and responsive search results presentation. The effectiveness of a search engine is conventionally determined by the relevance of the search results obtained in response to any particular query.

Early and many current search engines implement what is generally regarded as syntactic search methodologies. A Web-page crawler or spider is employed to wander the Web, retrieving pages for indexing. Various aspects of each Web-page, such as content, anchor text, and uniform resource locator (URL) connectivity, are retrieved and analyzed to derive various base metrics, such as word or term frequencies, connectivity graph weights, and other details. These base metrics are recorded in a search index progressively in concert with the on-going background operation of the spider.

In use, a user-provided query, consisting of one or more search words, is variously matched against words and word phrases in the search index, identifying potentially millions of Web-pages that contain occurrences of the query text. These resulting Web-pages may then be graded or ranked based on the base metrics, generally with the result of producing a singular linear list of Web-page references sorted by presumed relevance to the initially provided user query text. In many instances, the results list displayable to a user includes many hundreds if not thousands of Web-page with minimal identification of potential relevance in the form of a limited content sample centered on a query text occurrence.

Some current search engines implement semantic search methodologies. Although not subject to a well-settled definition, given the developing nature of the field, semantic search is generally associated with a contextually significant inference-based processing of the content contained in Web-pages. Contextual analysis is typically performed through automated semantic analysis using natural language processing (NLP) techniques to inference context, by extracting explicit context characterizing meta-data embedded within the Web-pages, or a combination of such techniques.

In NLP-based analysis, Web-page content retrieved by a Web spider is processed to identify significant word and phrase terms, such as noun phrases. These terms are then processed to characterize semantic usage context through various combinations of techniques, including latent semantic analysis (LSA) that in various forms relies upon knowledge mapping against pre-established concept ontologies, semantic maps, knowledge databases, and other components that enable inferencing term to context associations. NLP processing typically results in the generation of sets of term-mapped strength vectors correlated to Web-pages. These vector associations are persisted to a search engine database.

As an alternative to inferencing context directly from content, meta-data, typically implemented as embedded annotations using Resource Description Framework (RDF), Web Ontology Language (OWL), or similar mark-up, can be used to pre-define the semantic context of words and phrases embedded within Web-pages. The meta-data must be actively added to Web-pages either as part of the initial Web-page coding or in a subsequent annotation pass by the page owner or agent. When the Web-pages are subsequently retrieved through a spider process, the meta-data is extracted and cataloged. Often, a measure of semantic analysis is needed to derive corresponding term-mapped strength vectors appropriate for storage in the search engine database.

On presentation of a user query, a semantic search engine generally begins by determining a semantic context of a provided query text, typically using a form of latent semantic analysis. References to Web-page documents having corresponding semantic context vector associations can then be retrieved from the database. The retrieved references are sorted and ranked by the relative association of the semantic contexts of the query text and Web-page documents and, again, typically reported to the user as a singular linear list of Web-page references.

A number of significant problems persist with both semantic and syntactic search systems. In regard to syntactic systems, scaling issues tend to preclude indexing of substantial portions of the Web document collection. Often, Web-pages more than three or four levels deep within any given domain are trimmed from the search index to limit the overall size of the search index. With the continuing growth of both the extent and complexity, including depth, of Web-sites, the failure to index deep pages can and likely will result in relevant omissions in the document references returned in response to user queries. Even subject to depth constraints, the size of the created search index can become a fundamental limitation, requiring further trimming of the number of pages indexed, the nature and extent of base metrics collected, or both.

NLP-based semantic Web engines are generally constrained by the strength of the latent semantic analysis that can be performed. Generally, the search engine scope is constrained to a closely circumscribed subject matter area for which knowledge maps have been developed. The development of such knowledge maps are both time intensive and context dependent. NLP-based determinations of context associations are computationally intensive. The quality of meta-data based context associations are dependent on the quality and consistency of the annotation process. Further, for any user query, the relevance of the search results is inherently dependent on accurately determining the semantic context of the query text submitted. Query texts are characteristically short, giving little basis to discern context. Ultimately, any inaccuracy in the semantic context determination, either as derived for the query text or of the many Web-page documents, will directly impact the perceived relevance of the resulting list of Web-page references returned.

Consequently, a need exists for a better system and processes for determining and presenting substantively relevant search results.

### SUMMARY OF THE INVENTION

Thus, a general purpose of the present invention is to provide an efficient information retrieval system and methods by automatic clustering of ranked and categorized search objects.

This is achieved in the present invention by providing for the generation of a search results page that includes multiple search lists produced by multiple clustering operations applied to an initial match set of documents selected based on a user query. A first result list is constructed by clustering a top-n set of documents by primary domain address and sorting based on extrinsic ranking factors such that the first list includes a ranked and ordered list of primary domain linked anchor text. A second result list is constructed by clustering the top-n set of documents based on a unified ranked occurrence of keywords within the top-n set of documents. The generated second list contains a plurality of cluster class references with each of the cluster class reference including a ranked ordered sub-list of the keywords occurring within the top-n set of documents and respectively associated with the cluster class reference, each of the keywords of the ranked ordered sub-lists including linking references to a corresponding one of the top-n set of documents. A third result list is constructed by clustering the top-n set of documents based on a ranked frequency of occurrence of internally linked anchor texts. The generated third result list includes the top-n set of the internally linked anchor texts and respective ranked and ordered sub-lists of linking references to primary domain documents containing the corresponding one of the internally linked anchor texts.

Additional results lists can be constructed based on an expanded top-n selection of documents. A fourth result list is constructed by clustering a top-n set of documents selected from a set of documents that contain anchor text that includes the text of the user query. The anchor texts of this expanded top-n selection of documents are ranked and ordered, the corresponding documents are clustered by primary domain address and sorted based on extrinsic ranking factors. The fourth result list includes a top-n set of the anchor texts from the expanded top-n selection of documents and respective sub-lists of linking references to primary domain documents containing the corresponding one of the anchor texts. A fifth result list is constructed based on the expanded top-n selection of documents by ranking and ordering the documents based on a combination of clustering on internal link anchor text ranking, extrinsic document reference ranking, and keyword frequency of occurrence ranking. In preferred embodiments, this fifth list is presented as a top-n list of the anchor text that includes the text of the user query, with respective sub-lists of linking references to primary domain documents containing the corresponding one of the anchor texts, ranked and ordered keywords that occur within the a top-n set of documents that contain an query text including anchor text, and ranked and ordered internally linked anchor texts.

An advantage of the present invention is that the presentation of multiple results lists as part of a search results page, and preferably a single search results page, produces search results with a breadth and depth scope with distinctly greater cognitive value and relevance to a provided query text than that achieved through conventional search results generation techniques.

Another advantage of the present invention is that a dynamic clustering process is performed at query-time to produce responsive search results. Multiple clustering sub-processes produce distinct results lists that are then combined and presented as a comprehensive search results page. The underlying Web-page database and related document metrics are efficiently stored for fast access and is readily scalable.

A further advantage of the present invention is that the combination of multiple different dynamic clustering processes effectively produce semantically relevant results without requiring traditional semantic processing. Conventional NLP processing of document content, directly or dependent on the extraction of predefined meta-data, is not required. In addition, the present invention operates from knowledge inferentially identified in the document collection. Operation is not constrained to subject-matter areas defined by the construction of a semantic knowledge database.

### BRIEF DESCRIPTION OF THE DRAWINGS

FIG. 1 illustrates a preferred information retrieval environment for use of a preferred embodiment of the present invention.

FIG. 2 is a flow diagram showing a top-level information retrieval operating process as implemented in a preferred embodiment of the present invention.

FIGS. 3A and 3B presents graphical and representational illustrations of a search engine user interface Web-page, including search results produced through the execution of a preferred embodiment of the present invention.

FIG. 4 provides a flow diagram showing the collection and initial processing of page metrics in accordance with a preferred embodiment of the present invention.

FIG. 5 provides a flow diagram showing a preferred search results generation process as implemented in accordance with a preferred embodiment of the present invention.

FIG. 6 provides a flow diagram detailing a preferred related keywords list generation process as implemented in accordance with a preferred embodiment of the present invention.

FIG. 7 provides a flow diagram detailing preferred top sites list and categories list generation processes as implemented in accordance with a preferred embodiment of the present invention.

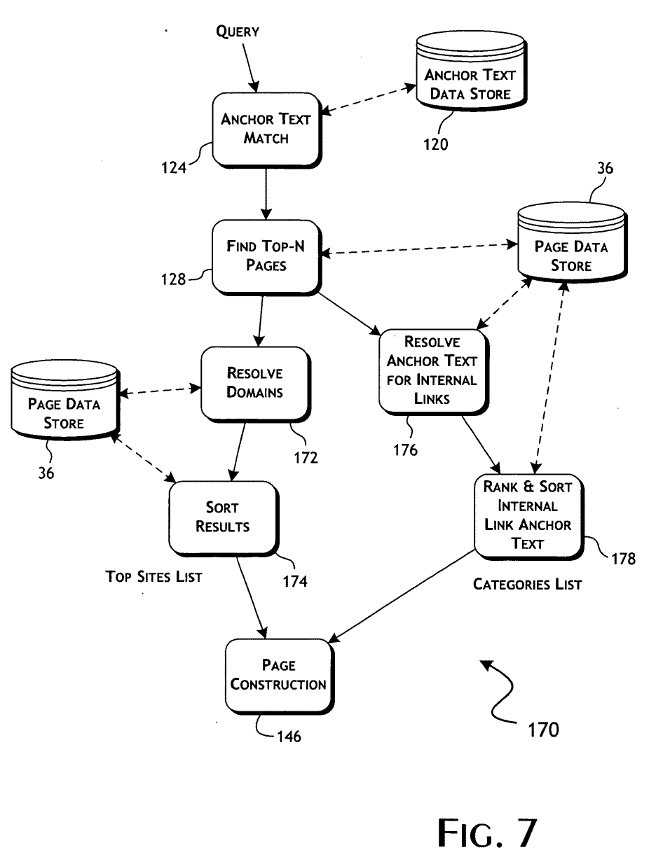

FIG. 8 provides a flow diagram detailing a preferred suggestions list generation process as implemented in accordance with a preferred embodiment of the present invention.

FIG. 9 provides a flow diagram detailing a preferred search list generation process as implemented in accordance with a preferred embodiment of the present invention.

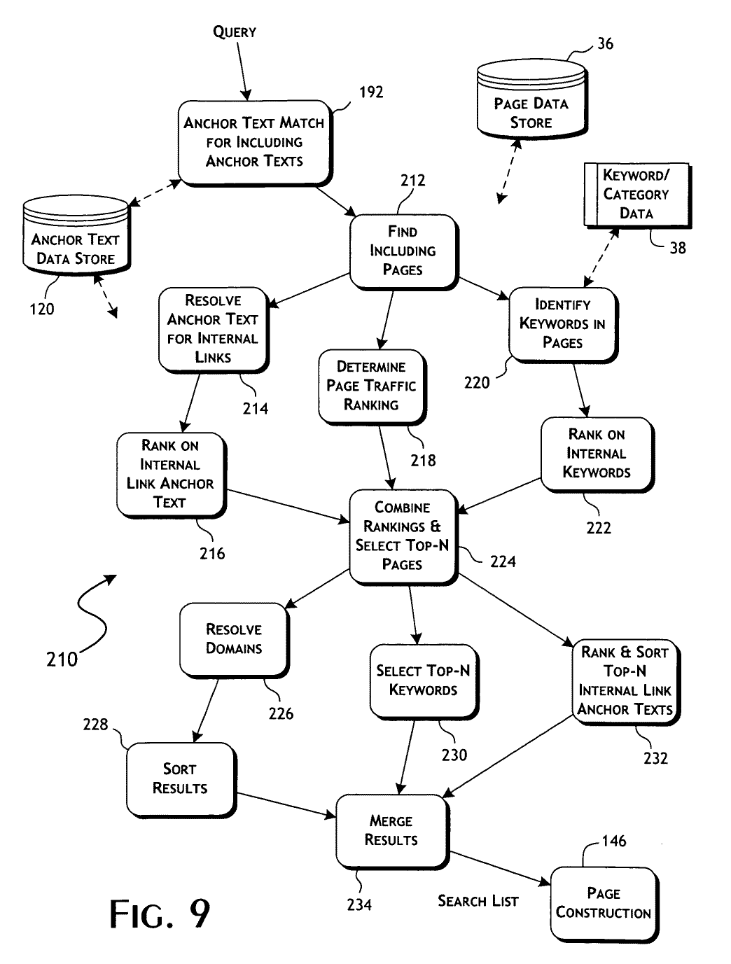

### DETAILED DESCRIPTION

The present invention provides a system for generating and presenting search results pages in relevant response to a query text provided by a search engine user utilizing automated clustering and ranking of information. In the preferred embodiments, the search is performed over a public, Web-based document collection, though the present invention is generally applicable to the searching of both public and private hyper-text or similarly linked document collections. In the following detailed description of the invention, the present invention will be described in terms of its preferred embodiments and, for clarity of discussion, like reference numerals will be used to designate like parts depicted in one or more of the figures.

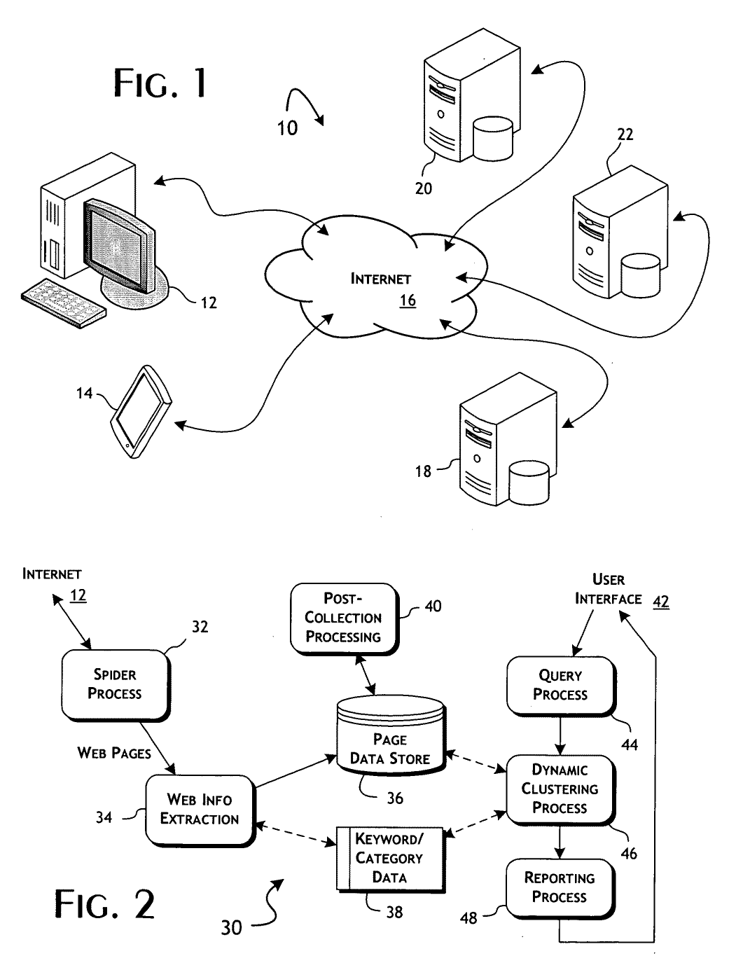

FIG. 1 generally illustrates a characteristic public, Internet-based operating environment 10 for a preferred embodiment of the present invention. Client computer systems 12, 14 provide user interfaces that enable users to interact through the Internet 16 with a server 18 executing a search engine application. The client computer systems 12, 14 may be conventional desktop computers and mobile devices of varying description, including notebook computers, Web-tablets, and Web-enabled cellular telephones. The search engine server 18 may be implemented as a single server system or cluster of conventional server computer systems that, further, may be geographically distributed. The search engine application provides for the collection and evaluation of Web-pages and similar documents through the Internet 16 from conventional Web-page server computer systems 20, 22, typically located geographically remote from the search engine server 18. User queries, as received through the user interfaces of the client computer systems 12, 14, are evaluated by the search engine application, with responsive search results pages being returned for display to the users.

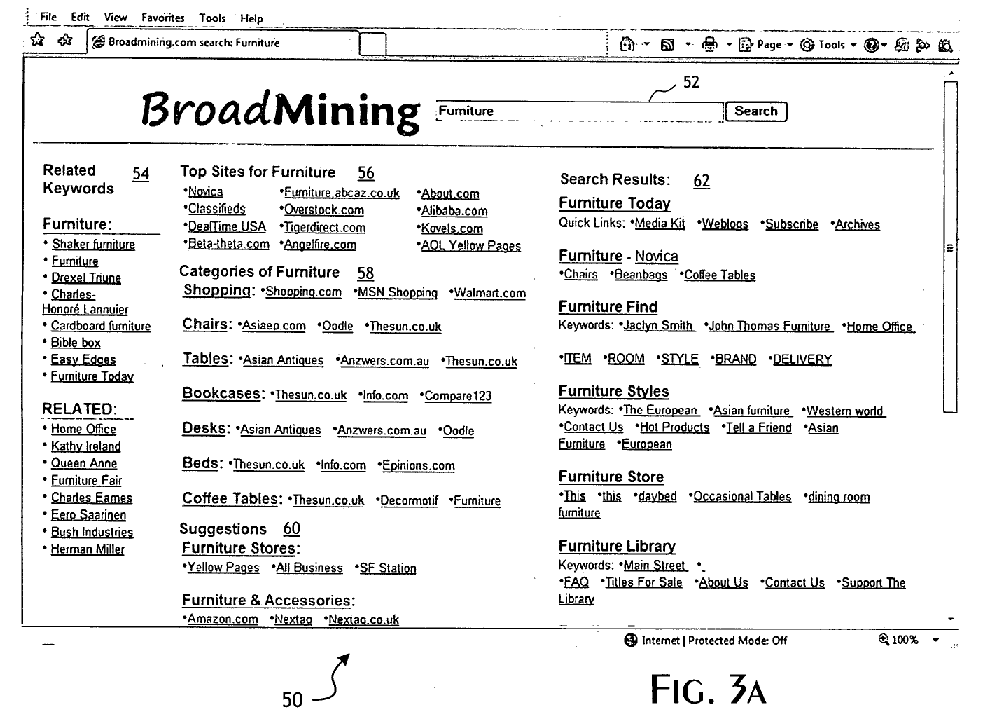

An information retrieval process 30, as implemented in a preferred embodiment of the present invention, is shown in FIG. 2. A spider process 32 is employed to progressively traverse a hyper-text connected graph of Web-pages accessible through the Internet 16. The spider process 32 is preferably not limited to examining Web-pages within a fixed depth from the root level of a domain. Rather, the spider process 32 preferably operates to examine and transfer all Web-pages within a domain to the search engine server 18 for Web-page information extraction 34. In alternate embodiments, the spider process 32 may evaluate base-line criteria in determining to report a Web-page for information extraction 34. These base-line criteria preferably may include page size, accessibility performance, and page quality metrics, such as the number of hyper-text references to the Web-page. In accordance with the present invention, the depth of a Web-page within a domain is not a singular or, in combination, significant, limiting constraint on the selection of a Web-page for information extraction 34.

The Web-page information extraction process 34 preferably operates to identify and extract information of defined nature from each Web-page. The extracted data is stored in a page data store 36. Principal among the information extracted from a Web-page are embedded hypertext references, including the corresponding anchor text, and keywords. For purposes of the present invention, the anchor text is the word or phrase that is ostensibly provides a user relevant description of the target destination of a hypertext reference. In conventional implementation, a hypertext reference will generally be of the form:

<a href=“http://travel.yahoo.com/destinations/”>Travel Destinations</a> where the domain is “yahoo.com,” the sub-domain is “travel.yahoo.com,” the first level sub-domain directory is “destinations,” and the anchor text is “Travel Destinations.”

Keywords are identified wherever occurring within the content of a Web-page and in the anchor text of hypertext references. In the extraction analysis of a Web-page, an established categorized list of keywords 38 is consulted. The keyword list 38 is preferably a general applicability ontology constructed as hierarchical categories with associated keywords, where the categories and keywords are represented by words or phrases. In the preferred embodiments of the present invention, the Wikipedia (www.wikipedia.org) article index is chosen to define the keyword list categories and anchor text instances within the Wikipedia article pages define the associated keywords. A current generation of the Wikipedia-based keyword list 38 provides approximately 400 million keywords.

The page data store 36 is preferably implemented as part of a database management system to provide for the storage of the Web-page extraction information, associated keyword information, and further metrics developed through a post-processing 40 of the extracted information. While high-performance relational systems can be effectively utilized, the current preferred embodiments of the present invention utilize an indexed table-based data manager optimized for read-mostly operations.

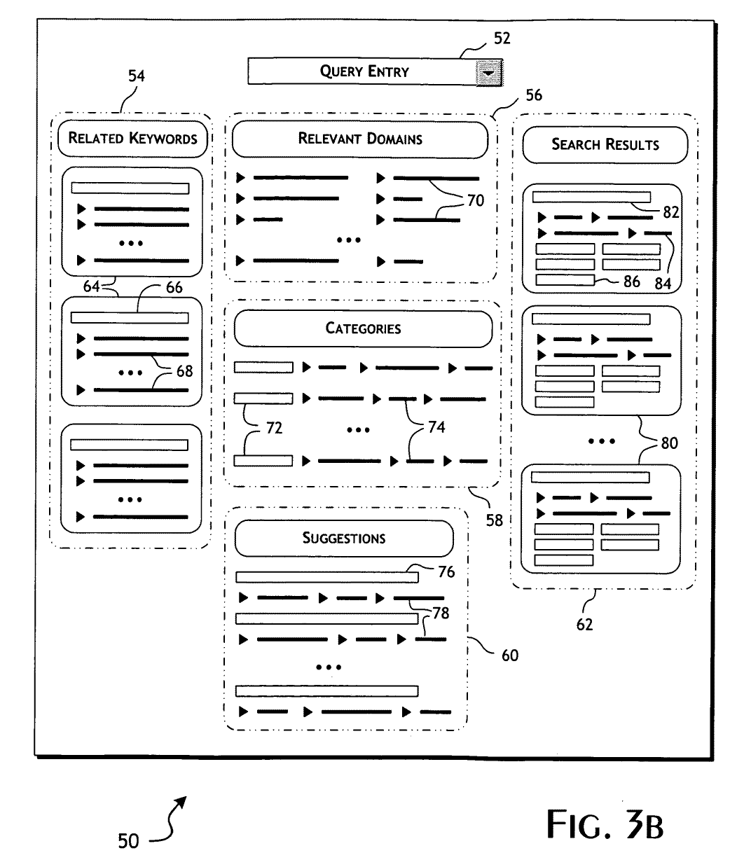

As the spider process 32 and development of the page data store 36 is generally a progressive, on-going process, an interactive, search engine interface process, separately accessible by users, is concurrently supported by the information retrieval system 30. A search engine user interface 42 presents preferably as a Web-page to users. A graphical representation 50 of a preferred search engine user interface 42 is shown in FIG. 3A. A query text, entered 52 by a user, is initially retrieved 44 through the interface 42. A dynamic clustering process 46 is then performed to, in general, perform a multi-modal word classification to generate, in real-time, multiple structural knowledge aspects that relate the query text to the information present in the page data store 36. These different aspects are then reported to the user generally in the form of aspect lists 54, 56, 58, 60, 62.

Referring to FIG. 3B, with regard to the presentation of a search results Web-page, a related keywords list 54 preferably provides a series of blocks 64, each listing a category 66 and corresponding sub-list of keywords 68 contextually specific to the query text entered 52. A relevant domains, or “top-sites,” list 56 presents a relevancy-ordered list of the domains 70 most contextually specific to the query text. A categories list 58 provides a relevancy-ordered list of categories 72 and corresponding relevancy rated domains specific to the query presented. A suggestions list 60 presents a set of categories 76 that are contextually related to the query text and corresponding sub-lists 78 of associated domain names. A search list 62 provides the results of a contextually related search as a series of blocks 80, identified by unique anchor texts 82 and including sub-lists of keywords 84 and inside-link related anchor texts 86.

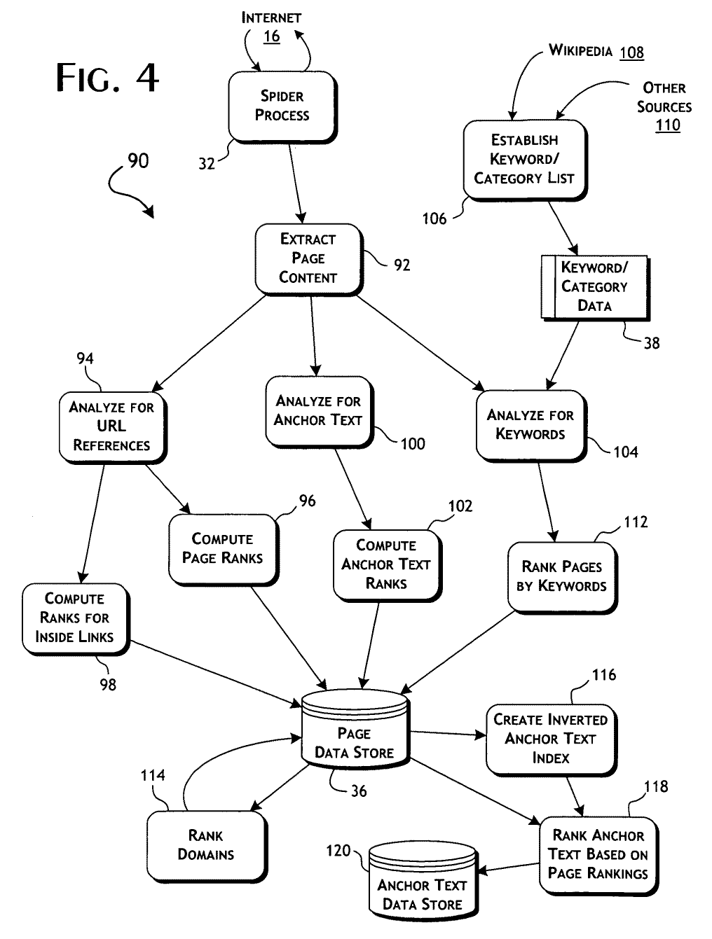

A preferred implementation of the background process 90 utilized in the development of the content and metrics for the page data store 36 is shown in FIG. 4. As the spider process 32 traverses the Internet 16, Web-pages, identified by their uniform resource locator (URL), are retrieved and processed to extract page content 92. Embedded hypertext references are identified 94 and collected to permit analysis of the connectivity graph between Web-pages both as occurring within the same domain, termed “inside links,” and referencing Web-pages in other domains, termed “external links.” A page rank metric is then computed for the page being analyzed 96. Preferably, the page rank algorithm computes the page rank metric for a page as a value representing a sum of the weighted significance of each hypertext reference to the Web-page. Weighted significance is preferably determined as a normalized value representing the page ranking of the source Web-page referencing the Web-page being analyzed. Preferably, an iterative solution is implemented to update and account for the change in page rank values of Web-pages referenced by hypertext references in the Web-page being analyzed. A basic, and presently preferred page ranking value can be determined based on domain traffic statistical information. Alternately, a connected-graph evaluation algorithm can be used to determine the relative ranking of Web-pages. An example of one such algorithm is described in U.S. Pat. No. 6,285,999, issued Sep. 4, 2001 to Lawrence Page.

Page rank values are also computed 98 specific to the domain of the Web-page being analyzed. The domain isolated page rank metric for a particular Web-page within a domain is preferably based on the frequency that the Web-page is referenced from an inside link. Additional ranking weight is given where the reference is from Web-page within a subdirectory relative to the Web-page being evaluated, with decreasing distance in the sub-directory tree also contributing to a greater ranking weight and where from a Web-page within the same sub-domain. Other factors increasing ranking weight include the relative ordering of the inside link reference target is on the Web-page being evaluated, with higher relative page positions being given greater weight, and the length of the inside link anchor text, with shorter texts being given greater relative weight. The Web-page URL, global and internal link page rank metrics, and embedded hypertext references are then stored to the page data store 36.

Retrieved Web-page content is also analyzed 100 to identify and extract the anchor text from embedded hypertext references. An anchor text ranking value is then determined 102. For the presently preferred embodiments, ranking values are determined for each literal anchor text expression, case insensitive, distinguishing for example “furniture” from “furnitures” from “table furniture.” In alternate embodiments of the present invention, term stemming and other term normalization techniques may be applied in addition to the reduction of case sensitivity. The ranking of a literal anchor text expression, as implemented in the preferred embodiments of the present invention, is computed as a weighed sum function of the normalized frequency of occurrence in the full set of Web-pages retrieved and analyzed, frequency of occurrence within individual Web-pages, and statistical order of occurrence within the Web-pages. In the preferred embodiments of the present invention, a table having rows of the form

TABLE 1
URL | { A[#a], B[#b], C[#c], ... }

is produced, where URL is a Web-page reference, the values A, B, C, . . . are unique anchor text used in link references to the row URL, and the values #a, #b, #c, . . . are the sum number of occurrences that the corresponding anchor text is used in link references to the row URL. The same anchor text instance may occur in link references to multiple URLs. Anchor text ranking metrics are generated to a table preferably with rows of the form

TABLE 2
A | rank_value { URL1, URL2, URL3, ... }

where the value A is a unique anchor text, rank_value is the ranking metric for the occurrence of A in the Web-pages identified by the corresponding set URL1, URL2, URL3, . . . . The generated tables are stored in the page data store 36.

The content of retrieved Web-pages is further analyzed 104 to identify the occurrence of keywords. A defined ontology of keywords is persisted in the keyword list 38, produced by extraction from the Wikipedia index 108, obtained from another knowledge representation source 110, or a combination of both. The currently preferred list 38 is obtained from Wikipedia 108. Once a list of all of the keywords occurring within a Web-page being analyzed is established, an in-page keyword ranking metric is determined for the Web-page 112. In the preferred embodiments of the present invention, a keyword ranking is accumulated as Web-pages are retrieved and analyzed 104. Keyword rankings are preferably computed as a weighted sum of the normalized frequency of occurrence in the full set of Web-pages retrieved and the frequency of occurrence within the individual Web-pages. In the preferred embodiments, the keyword ranking as

$$KeywordRank = m * ( log \frac{TotalPages}{C} ) * ( 1 + \frac{20}{1 + P} ) \qquad Eq . 1$$

where m is a weighting factor having a value of 1, where the keyword consists of a single word, or a value of 6 (empirically selected) where the keyword is a phrase of two or more words after filter exclusion of conjunctions and similar commonly used words, where C is a total count of keyword occurrences in all Web-pages evaluated, and where P is the index of the keyword in a list of all keywords occurring on a particular Web-page. The in-page keyword ranking metric is then preferably a normalized sum of the keyword rankings of the keywords that occur in the Web-page being analyzed. The Web-page URL, corresponding in-page keyword ranking metric, and list of page included keywords are then stored in the page data store 36.

As a post-collection step 40, generally performed after some significant amount of Web-pages metrics have been committed to the page data store 36, the domains represented by the analyzed Web-pages are ranked 114. In the preferred embodiments, the domain ranking metric is computed as an empirically weighted combination of domain traffic rankings obtained, in the current preferred embodiments, from third-party network analysis sites, including Alexa Internet, Inc. (www.alexa.com), Quantcast Corp. (www.quantcast.com), and Compete, Inc. (www.compete.com). Additionally, domain name rankings are determined in the post-collection step 40. These domain name rankings are used to identify a domain name aliases that will be perceived by user as more clearly descriptive of the domain. Heuristics are employed to recognize, reorder and expand sub-domain names and domain name/directory sets. A sub-domain such as “math.dept.stanford.edu” is preferably processed into the alias “Stanford Math Department.” A domain name “www.yahoo.com/news/international” is preferably processed into the alias “Yahoo International News.” In current preferred embodiments, the heuristics utilize basic pre-defined text pattern matching operations and look-ups directed to on-line directories, such as provided by the Open Directory Project (www.dmoz.org), to discover potential domain name aliases. Where, as typical, multiple aliases are determined for a domain name, an empirically determined weighting of the alias word length, distinctiveness of the words contained in the alias, and relative similarity to other aliases is used to rank the aliases. The top ranked aliases is selected as the preferred alias for the domain name. Where only one alias is determined, that alias is used if the ranking value exceeds an empirically set threshold level, essentially reflecting the distinctiveness of the alias. Where no alias and no distinctive alias is found, the selected alias is the domain name. The domain ranking metrics and aliases are stored correlated to a domain name list in the page data store 36.

Another preferred post-collection step 40 provides for the creation of an anchor text index correlated to Web-page ranking for each page where the anchor text occurs. Preferably, the metric is computed based on a normalized weighted sum of the frequency that hypertext references use an instance of a literal anchor text expression and the frequency that Web-page contain an instance of that literal anchor text expression. In the preferred embodiments of the present invention, Table 2, as stored by the page data store 36 and representing an inverted index of URLs to literal anchor text instances, is modified 116 by the addition of metric values representing the combined page rankings associated with each literal anchor text expression 118. The product is a table with rows of the form

TABLE 3
A | rank_value { URL1[#r1], URL2[#r2], URL3[#r3], ... }

where the additional factors #r1, #r2, #r3, . . . represent the page ranking of the corresponding Web-page times the faction of the number of occurrences of the anchor text literal A divided by the total number of anchor texts occurring in the Web-page. The resulting inverted index represented by Table 3 is then preferably stored in a fast searchable anchor text data store 120.

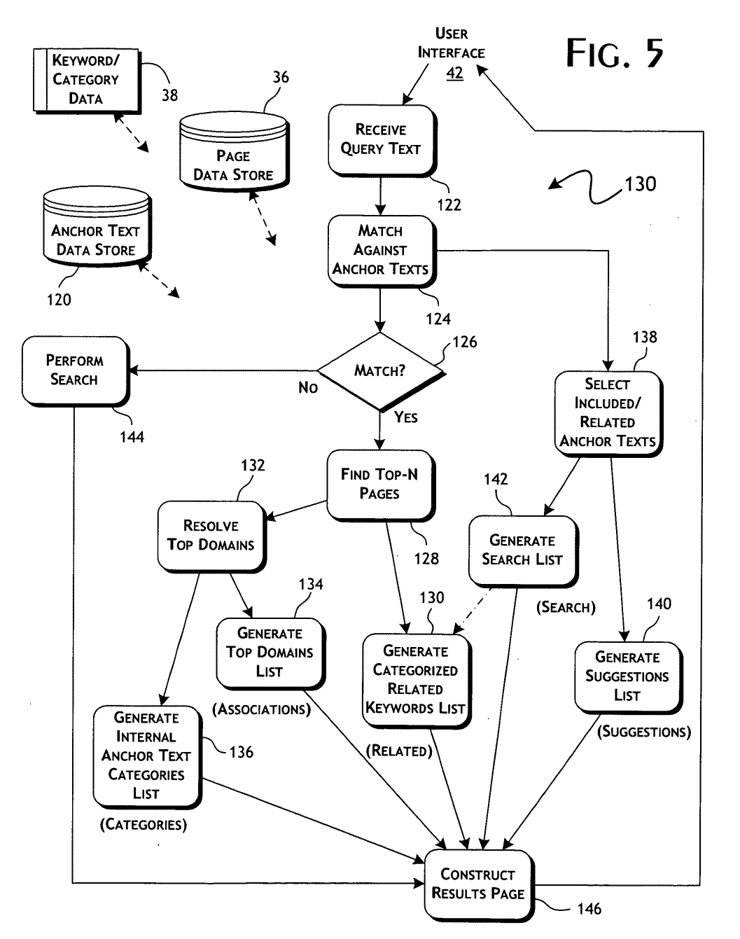

A preferred implementation of the interactive, search engine interface process 130 is shown in FIG. 5. In terms of general operation, a query text is received 122 as submitted by an end user through the user interface 42. The query text is matched 124, case insensitive, against-the inverted anchor text index as stored in the anchor text data store 120. Where a match is found 126, a top-n selection of Web-pages containing the matched anchor text are selected 128 and further processed to generate 130 the related keywords list 54. The top-n pages are further analyzed to resolve a list of top domains 132, from which the relevant domains list 56 is generated 134 and the categories list 58 is generated 136. Inexact anchor text matches 124 are identified and used to find inclusive related anchor texts 138. These related anchor texts are preferably used in the generation 140 of the suggestions list 60 and as the basis for generation 142 of the search results list 62. Where either none or an inadequate number of matched anchor texts are found 126, the query text may be submitted to an external conventional search engine 144. Also, in this case, the top-n elements of the generated search list 142 also then used to generate 130 the related keywords list 54. The multiple result lists generated 130,134, 136, 140, 142 and external search list 144 are combined to dynamically construct 146 a search results Web-page 50, generally as shown in FIG. 3A.

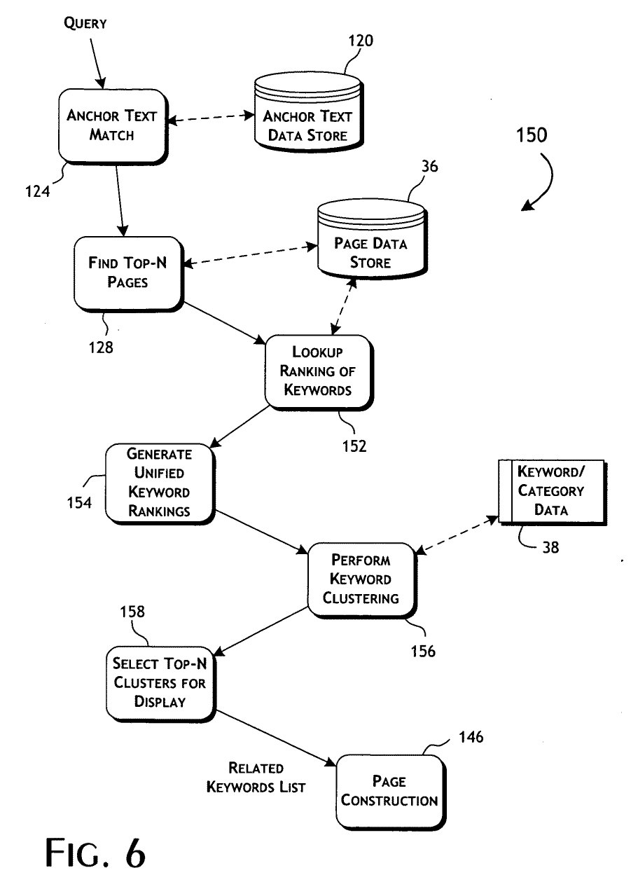

The process 150 of generating a related keywords list 130, as implemented in a preferred embodiment of the present invention, is provided in FIG. 6. In the currently preferred embodiments, the literal query text is matched 124, case insensitive, against the inverted anchor text index stored in the anchor text data store 120. In alternate embodiments, term stemming and other term normalization techniques may be applied to the query text consistent with the techniques used in the creation of the inverted anchor text index. Where a literal match is found 126, the top-n selection of corresponding Web-pages is performed 128. Based on metrics stored by the page data store 36, the set of Web-pages that contain the matched anchor text are first found and then ordered 152 by the keyword ranking 112 of those pages. The top-n ranked Web-pages are chosen based on an empirically set threshold in-page keyword rank value.

To generate the related keywords list 54, the keywords occurring within the selected top-n Web-pages are collected and clustered against the keyword list 38 ontology to identify a ranked series of categories 66 and respective sub-lists of keywords 68. In the preferred embodiments, a unified list of the keywords occurring within the top-n pages is collected and ordered 154 based on keyword ranking utilizing an iterative clustering process 156. The preferred general algorithm operates on Objects O1, . . . , On that have respectively assigned rank values r1, . . . , rn. Each object Oi can appear in one or more class sets C1, C2, . . . , Cn. The score of a particular class Ci is determined as

$$score ( Ci ) = {\sum }_{Oj ∈ Ci}^{j} f ( {r}_{j} ) \qquad Eq . 2$$

where the function η(rⱼ)can be defined as a function like

$$f ( {r}_{j} ) = \frac{1}{d + {r}_{j}} \qquad Eq . 3$$

where d is an empirically determined constant d≧0. The ordered ranking of a class Ci is then determined by sorting the class scores. As applied to the generation of the related keywords list 54, objects are keywords and the class sets are categories.

Where, as in the case of the related keywords list 54, an object Oi is to be displayed only in one class set, or category, a reductive iteration of the class ranking calculation is applied. That is, if Oi is present in the current top ranked class, the class scores for the lower ranked set of classes are recalculated excluding Oi and sorted to find the next top ranked class. The iteration can be repeated until exhaustion of the objects or some number of ranked classes are found. Thus, as implemented in the preferred embodiments of the present invention, starting with the highest ranked keyword present in the unified list, the highest-ranked category 66 associated that keyword is determined from the keyword list 38 utilizing Equations 2 and 3, using d=1, which is selected empirically as an inverse adjustment on ranking importance. The keywords associated with that category are then removed from the unified keyword list to a corresponding category sub-list 68. The next category is then selected based on the then highest ranked keyword remaining in the unified keyword list. The clustering process 156 repeats until the unified keyword list is exhausted. A top-n set of categories is selected 158 for reporting to the page construction process 148. The number n of categories reported, for presentation as the series of category blocks 64, is preferably a user selectable value, with a default of five. A lesser number of categories will be reported for presentation if the ranking of keywords falls below an empirically established threshold.

To generate, the relevant domains list 56, the results of the top-n selection 128 of anchor text corresponding Web-pages is used as the basis for identification of the relevant domains. Preferably, the URLs of the top-n Web-pages, as retrieved from the page data store 36, are clustered 172 to produce a unique list of the containing primary domains. The resulting domain list is then sorted 174 based on the relative proportion of the top-n Web-pages that are clustered in each domain. The resulting ordered list is then presented for page construction 146.

Generation of the categories list 58 preferably also proceeds from the results of the top-n selection 128 of anchor text corresponding Web-pages. The hypertext references embedded in these top-n Web-pages are evaluated to identity those that are internally linked per domain and the corresponding anchor texts are collected into an internal anchor text list 176. These anchor texts are then ranked, utilizing the collected metrics present in the page data store 36, to produce a sorted internal anchor text list 178. For purposes of ranking, as implemented in an alternate embodiment of the present invention, a stop list can be employed to functionally combine internal anchor texts with inconsequential differences. Additionally, internal anchor texts exceeding a system defined length are automatically excluded from the internal anchor text list. In the preferred embodiments of the present invention, the resulting internal anchor text list is sorted based on the precomputed anchor text ranks, the frequency of occurrence within the top-n Web-pages, and the averaged order of occurrence within the individual top-n Web-pages. The ranking score (S) for a particular anchor text instance (T), for purposes of sorting, is preferably determined as

$$S ( T ) = {\sum }_{i = 1}^{n} ( \frac{1}{{r}_{pi}} + \frac{1}{{r}_{i}} ) \qquad Eq . 4$$

where the value of rₚᵢ represents the page ranking of a Web-page i in the set of top-n Web-pages and the value of rᵢ is the ranking of the anchor text T in a Web-page 1. A top-n set of-the ranked and sorted internal anchor texts is then selected. Next, sub-lists for each of the top-n set of the internal anchor texts are respectively constructed to include the top-n domains of the Web-pages that contain the corresponding internal anchor texts. The internal anchor texts and domain sub-lists are then presented for page construction 146.

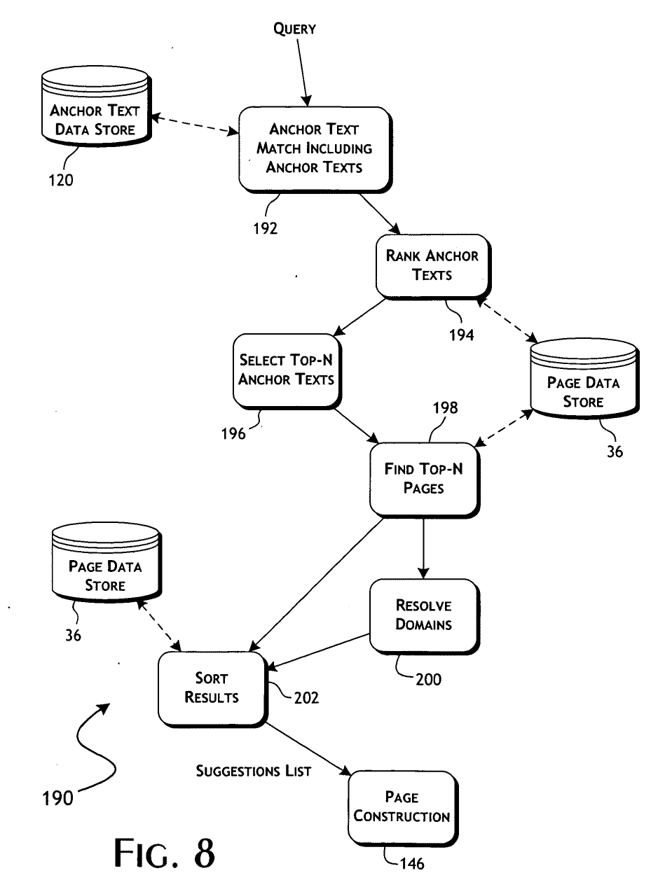

The suggestions list 60 is generated preferably in accordance with the process shown in FIG. 8. The query text is initially matched 192 against the anchor text index stored by the anchor text data store 120. For the preferred embodiments of the present invention, the match is performed inclusively, case insensitive, and subject to a stop list to ignore inconsequential words within both the query text and anchor texts. Thus, a query text of “furniture” will be found to match a broader set of anchor texts, such as “Furniture,” “furniture stores,” “the furniture reseller,” and “Furniture &Accessories.” These inclusive anchor texts are collected into a list and ranked 194 based on a lookup of the corresponding anchor text ranking metrics stored in the page data store 36. Sorted by the anchor text rankings, a top-n anchor texts are selected 196. The top-n Web-pages, determined based on frequency of occurrence of the included anchor text within hypertext references embedded in the Web-pages, are then selected 198. A unique list of the domains that contain these top-n Web-pages is resolved 200. The domain name list is then sorted 202 based on the page ranking metrics stored by the page data store 36. Each domain name represents a category 76 heading within the suggestions list 60. The top-n Web-pages are clustered based on the highest frequency of occurrence included anchor text, sorted based on Web-page ranking, and associated with the categories 76 as the sub-lists 78. The resulting category 76 and sub-list 87 data is then provided for page construction 146.

The search list 62, as implemented in preferred embodiments of the present invention, presents a composite of search result aspects relevant to a query text instance. Included anchor texts are initially matched from the query text 192. The set of Web-pages that contain these included anchor texts are the collected 212 and processed through multiple paths. A first path resolves a subset list where the included anchor texts are exclusively referenced by internal links 214. Anchor text rankings, as retrieved from the page data store 36, are associated with the internal included anchor texts 216. A second path utilizes domain-based traffic rankings to rank the included anchor text Web-pages. Domain-based traffic rankings can be obtained from conventional Web-tracking services, such as Alexa, Quantcast, and Compete. Each of the included anchor text Web-pages is assigned a traffic ranking value corresponding to its domain 218. A third path ranks the included anchor text Web-pages based on keywords. Keywords occurring within the included anchor text Web-pages, as identified utilizing the keyword list 38, are identified 220. Each of the included anchor text Web-pages has a determined keyword rankings computed as a normalized sum of the keyword rankings for the subset of keywords found to occur within the Web-page 222.

The internal linked anchor text rankings, domain traffic rankings, and Web-page keyword rankings are then combined 224 to produce composite rankings for the Web-pages. The Web-pages are sorted by the composite rankings and a top-n set is selected. From this top-n composite set of Web-pages, a unique list of the containing domains is created 226 and sorted 228 based on the domain ranking metrics stored by the page data store 36. The set of keywords appearing in this top-n composite set of Web-pages is also collected and sorted based on a combined weighted frequency of occurrence in the full top-n composite set of Web-pages and frequency of occurrence in individual pages of the top-n composite set of Web-pages. A top-n set of the resulting most frequently occurring keywords is then created 230. Finally, the set of internal link anchor texts contained in the top-n composite set of Web-pages are selected, ranked according to the anchor text ranking metrics stored by the page data store 36, and then sorted by their rankings.

The sorted domain sub-list 228, sorted top-n keywords, and set of internal linked anchor texts are then merged to produce the search results list 62. In the preferred embodiments, the merge operation 234 constructs blocks of data 80, each containing, as applicable, an included anchor text heading 82, a sub-list of keywords 84 specific to the included anchor text heading 82, and a sub-list of the internal-link anchor texts 86. These blocks of data are then presented for page construction 146.

Those of ordinary skill will readily appreciate that subsets and additional sets of query text search aspects may be utilized in the construction of the search results Web-page 50 and that additional and alternate ranking factors can be utilized throughout. Those of ordinary skill will also appreciate that the value of the term top-n can represent different absolute values in different contexts of usage.

In view of the above description of the preferred embodiments of the present invention, many modifications and variations of the disclosed embodiments will be readily appreciated by those of skill in the art. It is therefore to be understood that, within the scope of the appended claims, the invention may be practiced otherwise than as specifically described above.

1. A computer implemented method of presenting a search report identifying documents relevant to an input query text, said method comprising the steps of:
a) first determining a primary top-n set of documents corresponding to a query text, wherein said query text is provided through a user interface, wherein said first determining step is operative to match said query text against a plurality of terms stored in a database, wherein said plurality of terms correspond to anchor texts occurring within documents of an analyzed document collection, wherein said plurality of terms are associated with sets of document addresses identifying the documents of anchor text occurrence, and wherein said primary top-n set of documents correspond to those top ranked based on frequency of occurrence of the matched subset of said plurality of terms;
b) second determining a set of keywords occurring within said primary top-n set of documents, wherein said database stores a pre-established keyword ontology with keyword associated ranking values determined with respect to said analyzed document collection, and wherein said pre-established keyword ontology includes said set of keywords;
c) clustering said set of keywords into an ordered plurality of keyword lists dependent on a ranked relatedness determined by reference to said pre-established keyword ontology, said step of clustering including the iterative steps of
i) computing a unified keyword ranking for each of said set of keywords with respect to said primary top-n set of documents and said pre-established keyword ontology keyword associated ranking values;
ii) selecting a top-n subset of said set of keywords based on said unified keyword ranking as a keyword cluster; and
iii) removing said top-n subset from said set of keywords and repeating said step of clustering until a predetermined number of clusters are found or exhausting said set of keywords;
d) presenting, through said user interface, said ordered plurality of keyword lists as categorized keyword lists.

2. The computer implemented method of claim 1 further comprising the steps of:
a) first resolving a unique list of primary domain addresses corresponding to said primary top-n set of documents; and
b) second selectively resolving aliases for each of said primary domain addresses of said unique list includes the steps of
i) matching a pattern against each said primary domain address to resolve a pattern defined alias;
ii) performing a lookup of each said primary domain address against a list of predetermined domain aliases;
iii) selecting aliases for said primary domain addresses, wherein each said primary domain address is a default alias to create a list of aliases corresponding to said unique list of primary domain addresses;
b) sorting said list of aliases into a ranked order evaluated dependent on predetermined fitness criteria; and
c) presenting, through said user interface, said list of aliases as a top-n list of domains.

3. The computer implemented method of claim 2 further comprising the steps of:
a) collecting a unique set of anchor text instances corresponding to said plurality of terms restricted to internal document link references contained by said primary top-n set of documents;
b) sorting said unique set of anchor text instances into a ranked order evaluated dependent on predetermined ranking criteria including frequency of occurrence weighted by order of occurrence;
c) selecting a top-n ranked subset of said unique set of anchor text instances;
d) performing said second selectively resolving aliases step against said top-n ranked subset to resolve a top-n internal domain alias list; and
e) presenting, through said user interface, said unique set of anchor text instances and respectively associated aliases of said top-n internal domain alias list.

4. The computer implemented method of claim 3 further comprising the steps of:
a) third determining a secondary top-n set of documents corresponding to said query text, wherein said third determining step is operative to identify a second plurality of terms that include said query text, and wherein said secondary top-n set of documents are those top ranked based on frequency of occurrence of said included subset of said plurality of terms;
b) fourth determining a top-n set of anchor texts occurring within said secondary top-n set of documents;
c) ranking said top-n set of anchor texts based on predetermined criteria including frequency of occurrence within said analyzed document collection;
d) selecting a tertiary top-n set of documents representing those documents having the highest frequency of occurrence of said top-n set of anchor texts;
e) resolving a tertiary list of domain names corresponding to said tertiary top-n set of documents;
f) performing said second selectively resolving aliases step against said tertiary list to resolve a top-n tertiary domain alias list; and
g) presenting, through said user interface, said top-n set of anchor texts and respectively associated aliases of said top-n tertiary domain alias list.

5. The computer implemented method of claim 4 further comprising the steps of:
a) submitting each of said second plurality of terms to a predetermined external search engine to retrieve a corresponding identification of a quaternary top-n set of document addresses;
b) determining first top-n sets of keywords that occur within the documents identified as corresponding to each of said second plurality of terms;
c) determining second top-n sets of primary domain aliases for the documents identified as corresponding to each of said second plurality of terms; and
d) presenting, through said user interface, a list of said second plurality of terms including, as sub-lists corresponding ones of said first top-n sets of keywords and second top-n sets of primary domain aliases.

6. A computer implemented method of presenting a search results Web-page identifying documents of an Web-based document collection responsive to an input query text presented through a Web-based user interface, said method comprising the steps of:
a) generating a plurality of results lists responsive to an input query text presented through a Web-based user interface, wherein said plurality of results lists are derived from a top-n set of documents found by
i) matching said input query text to a plurality of terms representing anchor text instances occurring within a Web-based document collection to obtain a list of documents containing matched instances of said plurality of terms;
ii) ordering said list of documents based on a keyword rank value determined for each document proportional to the frequency of occurrence of predetermined keywords in an analyzed set of said Web-based document collection and the frequency of occurrence of said predetermined keywords in said document; and
iii) selecting, based on keyword rank value, said top-n set of documents having at least a predetermined threshold keyword rank value,
wherein said plurality of lists include
i) a top-n domains list determined by aggregation of the domains of occurrence of said top-n set of documents;
ii) a related keywords list determined from an iterative reduction clustering of keyword occurrences within said top-n set of documents; and
iii) a categories list determined from the set of internal link anchor texts occurring within respective domain hierarchies; and
b) compositing said plurality of results lists together in a search results Web-page for presentation though said Web-based user interface.

7. The computer implemented method of claim 6 wherein said plurality of terms represent unique literal anchor text instances.

8. The computer implemented method of claim 6 wherein said predetermined keywords are obtained from an established Web-based ontology.

9. The computer implemented method of claim 6 wherein entries in said top-n domains list are selectively literate aliases of corresponding domain names.

10. The computer implemented method of claim 6 wherein said step of generating generates one or more additional results lists responsive to said input query text derived from an alternate top-n set of documents found by
a) resolving a subset of said plurality of terms that include said input query text;
b) selecting an alternate list of documents containing said subset of said plurality of terms;
c) ranking said alternate list of documents based on metrics including frequency and order of occurrence of instances of said subset of said plurality of terms in each of said alternate list of documents; and
d) selecting said alternate top-n set of documents from said alternate list set of documents,
wherein said additional results lists includes a suggestions list determined from said subset of said plurality of terms and corresponding sub-lists determined by aggregation of the domains of occurrence of said alternate top-n set of documents.

11. The computer implemented method of claim 10 wherein said additional results lists includes a search list determined from said alternate top-n set of documents.

12. A computer implemented method of producing a search results Web-page in response to the presentation of a user query, said method comprising the steps of:
a) evaluating a user query text provided through a Web-based user interface to select a top-n set of Web-page documents, wherein said Web-page documents are selected based on ranked frequency of occurrence of said user query text in said Web-page documents;
b) generating a plurality of result lists, including:
i) a first result list constructed by a first clustering said top-n set of Web-pages documents by primary domain address and sorting based on predetermined extrinsic ranking factors, said first list containing primary domain address identifying anchor text with respective linking references to said primary domain addresses;
ii) a second result list constructed by a second clustering said top-n set of Web-page documents based on a unified ranked occurrence of predetermined keywords within said top-n set of Web-page documents, said second list containing a plurality of cluster class references with each said cluster class reference including a ranked ordered sub-list of said predetermined keywords occurring within said top-n set of Web-page documents and respectively associated with said cluster class reference, each said predetermined keywords of said ranked ordered sub-lists including linking references to a corresponding one of said top-n set of Web-page documents;
iii) a third result list constructed by a third clustering said top-n set of Web-page documents based on a ranked frequency of occurrence of internally linked anchor texts, said third result list including a top-n set of said internally linked anchor texts and respective ranked and ordered sub-lists of linking references to primary domain Web-pages containing the corresponding one of said internally linked anchor texts; and
c) displaying said plurality of result lists together in a search results Web-page though said Web-based user interface.

13. A computer implemented method of producing a search results Web-page in response to the presentation of a user query, said method comprising the steps of:
a) deriving a plurality of keywords from an analyzed set of Web-pages dependent on a user query text presented through a user interface;
b) associate keyword values with said plurality of keywords, said keyword values being determined in relation to said analyzed set of Web-pages;
c) performing an iterative reduction clustering of said plurality of keywords based on said associated keyword values to obtain a plurality of keyword lists; and
d) displaying said plurality of keyword lists as a list set component of a search results Web-page through said user interface.

14. The computer implemented method of claim 13 wherein said step of deriving comprises the steps of:
a) matching said user query text to anchor text occurrences within said analyzed set of Web-pages;
b) first selecting a subset of said analyzed set of Web-pages having a greatest ranked significance of matches of said user query text to anchor text occurrences within said analyzed set of Web-pages; and
c) second selecting the keywords, identified with respect to a predetermined keyword list, occurring within said subset of said analyzed set of Web-pages as said plurality of keywords.

15. The computer implemented method of claim 14 wherein said step of performing said iterative reduction clustering comprises the steps of:
a) ranking said plurality of keywords with respect to a plurality of classes, wherein each of said plurality of keywords occurs in one or more of said plurality of classes;
b) third selecting a class of said plurality of classes having a greatest ranked value determined based on the combined keyword values of said plurality of keywords associated with said class;
c) reserving said class and said plurality of keywords associated with said class as a keyword list of said plurality of keyword lists; and
d) repeating said third selecting and reserving steps with respect to the remaining classes of said plurality of classes.

16. A computer implemented method of producing a search results Web-page in response to the presentation of a user query, said method comprising the steps of:
a) identifying a plurality of Web-pages from an analyzed set of Web-pages as corresponding to a user query text presented through a user interface;
b) resolving a domain list corresponding to said plurality of Web-pages;
c) sorting said domain list based on predetermined criteria including the number of said plurality of Web-pages corresponding to each domain within said domain list; and
d) displaying said domain list in sorted order as a list set component of a search results Web-page through said user interface.

17. The computer implemented method of claim 16 wherein said step of identifying includes the steps of:
a) matching said user query text to anchor text occurrences within said analyzed set of Web-pages; and
b) first selecting a subset of said analyzed set of Web-pages having a greatest ranked significance of matches of said user query text to anchor text occurrences within said analyzed set of Web-pages as said plurality of Web-pages.

18. The computer implemented method of claim 17 wherein said step of displaying includes determining a display text for each domain within said domain list utilizing predetermined criteria including an open directory-based lookup of categorized domain correspondences, the default determined display text being a textual representation of the corresponding domain name.

19. A computer implemented method of producing a search results Web-page in response to the presentation of a user query, said method comprising the steps of:
a) identifying a plurality of Web-pages from an analyzed set of Web-pages as corresponding to a user query text presented through a user interface;
b) resolving an anchor text list from said plurality of Web-pages, wherein said anchor text list includes the anchor text of internal links occurring within said plurality of Web-pages;
c) ranking each anchor text of said anchor text list based on predetermined criteria including the frequency and relative location of occurrence in said plurality of Web-pages;
d) displaying said anchor text list in sorted order, based on relative ranking, as a list set component of a search results Web-page through said user interface.

20. The computer implemented method of claim 19 further comprising the steps of:
a) identifying from said plurality of Web-pages for each anchor text of said anchor text list a corresponding set of Web-pages;
b) resolving, for each said corresponding set of Web-pages, a corresponding domain list;
c) sorting each said domain list based on predetermined criteria including the number of said corresponding set of Web-pages corresponding to each domain within said corresponding domain list; and
d) displaying said corresponding domain lists in sorted order in respective combination with said anchor text list.

21. The computer implemented method of claim 20 wherein anchor texts are resolved uniquely based on the literal text of the anchor texts.

22. The computer implemented method of claim 20 wherein said step of resolving includes the step of determining an adjusted anchor text subject to predetermined criteria including exclusion of predetermined words and wherein anchor texts are resolved uniquely based on said adjusted anchor texts.

23. A computer implemented method of producing a search results Web-page in response to the presentation of a user query, said method comprising the steps of:
a) identifying a plurality of Web-pages from an analyzed set of Web-pages as corresponding to a user query text presented through a user interface, wherein said step of identifying selects said plurality of Web-pages dependent on matching anchor texts, occurring within Web-pages of said analyzed set of Web-pages, with predetermined portions of said user query text;
b) first resolving an anchor text list including said matched anchor texts;
c) sorting said anchor text list based on predetermined criteria including the number of said plurality of Web-pages corresponding to each anchor text within said anchor text list; and
d) displaying said anchor text list in sorted order as a list set component of a search results Web-page through said user interface.

24. The computer implemented method of claim 23 further comprising the steps of:
a) second resolving, for each said matched anchor text, a corresponding set of web-pages containing said matched anchor text from said plurality of Web-pages;
b) third resolving, for each said corresponding set of Web-pages, a corresponding domain list;
c) sorting each said corresponding domain list based on predetermined criteria including the number of said corresponding set of Web-pages corresponding to each domain within said corresponding domain list; and
d) displaying said corresponding domain lists in sorted order in respective combination with said anchor text list.

25. The computer implemented method of claim 24 wherein said step of displaying includes determining a display text for each domain within each said domain list utilizing predetermined criteria including an open directory-based lookup of categorized domain correspondences, the default determined display text being a textual representation of the corresponding domain name.

26. The computer implemented method of claim 25 wherein said step of identifying includes the step of matching an adjusted anchor text against an adjusted user query text, wherein said adjusted anchor text and said adjusted user query text are discriminated based on predetermined criteria including exclusion of predetermined words.

27. The computer implemented method of claims 13, 16, and 19 wherein said list set components are displayed together on said search results Web-page.

28. The computer implemented method of claims 14, 16, and 20 wherein said list set components are displayed together on said search results Web-page.

29. The computer implemented method of claims 13, 16, 19, and 23 wherein said list set components are displayed together on said search results Web-page.

30. The computer implemented method of claims 14, 16, 20, and 24 wherein said list set components are displayed together on said search results Web-page.
